(19) United States
(12) Patent Application Publication
(10) Pub. No.: US 2012/0214909 A1
(43) Pub. Date: Aug. 23, 2012

(54) LOW PH SOY FLOUR-NON UREA DILUENT AND METHODS OF MAKING SAME

(75) Inventors: James M. Wescott, Waunakee, WI (US); Michael J. Birkeland, Edgerton, WI (US)

(73) Assignee: HERCULES INCORPORATED, Wilmington, DE (US)

(21) Appl. No.: 13/397,829

(22) Filed: Feb. 16, 2012

Related U.S. Application Data
(60) Provisional application No. 61/443,841, filed on Feb. 17, 2011.

(51) Int. Cl. C09J 189/00; C09J 131/04

(52) U.S. Cl. 524/9

(57) ABSTRACT

The present invention provides an improved composition of soy with a non-urea diluent at a pH of less than 5.0, having improved viscosity stability with excellent wet and dry strengths, with more efficient production and lower production costs. Optionally, the composition may also include adding a crosslinking agent, additional diluent or both to the soy-non urea diluent adhesive and/or adding an emulsified or dispersed polymer.

This application claims the benefit of provisional application No. U.S. 61/443,841, filed Feb. 17, 2012, the entire contents of which are hereby incorporated by reference.

### FIELD OF THE INVENTION

The present invention provides a composition and method of making an adhesive by combining a non-urea based diluent with soy flour and lowering the pH to less than 5.

### BACKGROUND OF THE INVENTION

Adhesives derived from protein-containing soy flour first came into general use during the 1920's (see, e.g., U.S. Pat. Nos. 1,813,387, 1,724,695 and 1,994,050). Soy flour suitable for use in adhesives was, and still is, obtained by removing some or most of the oil from the soybean, yielding a residual soy meal that was subsequently ground into extremely fine soy flour. Typically, hexane is used to extract the majority of the non-polar oils from the crushed soybeans, although extrusion/extraction methods are also suitable means of oil removal.

The resulting soy flour was then, generally, denatured (i.e., the secondary, tertiary and/or quaternary structures of the proteins were altered to expose additional polar functional groups capable of bonding) with an alkaline agent and, to some extent, hydrolyzed (i.e., the covalent bonds were broken) to yield adhesives for wood bonding under dry conditions. However, these early soybean adhesives exhibited poor water resistance, strictly limiting their use to interior applications. Moreover, they were very low in solids, typically less than 20%, and were often very thick and non sprayable.

In the 1920's, phenol-formaldehyde (PF) and urea-formaldehyde (UF) adhesive resins were first developed. Phenol-formaldehyde and melamine modified urea-formaldehyde resins were exterior-durable, but had high raw materials costs that initially limited their use. World War II contributed to the rapid development of these adhesives for water and weather resistant applications, including exterior applications. However, protein-based adhesives, mainly soy-based adhesives that were often combined with blood or other proteins, continued to be used in many interior applications.

Currently, interior plywood, medium-density fiberboard (MDF) and particleboard (PB) are primarily produced using urea-formaldehyde (UF) resins. The latter two requiring low viscosity/sprayable adhesive systems to be commercially viable. Although very strong, fast curing, and reasonably easy to use, these UF resins lack hydrolytic stability along the polymer backbone. This causes significant amounts of free formaldehyde to be released from the finished products (and ultimately, inhaled by the occupants within the home). There have been several legislative actions to push for the reduction of formaldehyde emissions when used in interior home applications (Health and Safety Code Title 17 California Code of Regulations Sec. 93120-93120.12, and the 2010 United States “Formaldehyde Standards for Composite Wood Products Act”.

Exterior grade panels, such as plywood and oriented strand board (OSB) are most often produced with phenol formaldehyde or polymeric methylene diphenyl diisocyanate (pMDI) adhesives. For OSB, the application requires a low viscosity adhesive rendering it suitable for spraying, most often applied via a spinning disc atomizer.

Soy-based adhesives can use soy flour, soy protein concentrates (SPC), or soy protein isolates (SPI) as the starting material. For simplicity, the present disclosure refers to all soy products that contain greater than 20% carbohydrates as “soy flour”. Soy flour is less expensive than SPI, but also contains high levels of carbohydrates, requiring more complex crosslinking techniques, as crosslinking results in the much improved water resistance of the soy-based adhesives.

SPC contains a greater amount of protein than soy flour, but contains less protein than SPI. Typically, SPC is produced using an alcohol wash to remove the soluble carbohydrates.

SPI is typically produced through an isoelectric precipitation process. This process not only removes the soluble sugars but also removes the more soluble low molecular weight-proteins, leaving behind mainly high molecular weight-proteins that are optimal for adhesion even without modification. As a result, SPI makes a very strong adhesive with appreciable durability. However, SPI is quite costly, and is therefore not an ideal source of soy for soy-based adhesives. SPI based adhesives also suffer from very low solids and this results in an unacceptable level of moisture in the mat. Thus, there is a strong need to produce high quality adhesives from soy flour that are high in solids, yet still low enough in viscosity to allow for common spray application techniques to be employed.

U.S. Pat. No. 7,252,735 to Li et al. (Li) describes soy protein crosslinked with a polyamido-amine epichlorohydrin-derived resin (PAE). Li describes these particular PAEs, which are known wet strength additives for paper, in many possible reactions with protein functional groups. In Li, SPI is denatured with alkali at warm temperatures and then combined with a suitable PAE resin to yield a water-resistant bond. Li does not use a non-urea diluent, nor does he recognize the significance of a less than 5 pH for long term stability of soy-PAE systems.

U.S. Pat. No. 7,345,136 to Wescott describes a method for base denaturing soy flour in preparation for copolymerization by the direct addition of formaldehyde and phenol. The pH of the system is then lowered to a <5 level. Such a method, if applied to this invention would result in very high viscosity and low solids as a result of the excessive alkali denaturation step; rendering the adhesive impractical for PB, MDF or OSB applications. Alternatively, if the method of this invention is applied to the process of Wescott (U.S. Pat. No. 7,345,136) immediate gelation is realized when formaldehyde is added to the soy flour. This is a result of an insufficient level of denaturation for that process. Clearly, this present invention is of a significantly different soy conformation than that previously described.

Brady showed in U.S. patent application Ser. No. 12/287,394 that diluents can be used with soy flour and with certain crosslinkers to produce low viscosity adhesives, but Brady teaches that the “the pH is typically in the range of 5-10”. In this present invention, the pH is always less than 5. The lower pH is critical to allow for sufficient stability between the soy flour and certain crosslinkers, such as polymeric methylene diphenyl diisocyanate (pMDI) and PAR

### SUMMARY OF THE INVENTION

The present invention provides a composition and method of making an adhesive by combining a non-urea diluent and soy flour with a pH of less than 5, to produce a commercially viable adhesive. The term diluent in this invention represents any non-urea diluent capable of producing a homogeneous mixture with soy flour.

In one embodiment of the present invention, the soy flour is dispersed in a water and non-urea diluent mixture and the pH is lowered to a pH of less than 5.0, preferably less than 4.5, but greater than 2.0 and allowed to stir for at least 1 minute. Void of any additional crosslinking inclusion, this will result in a stable soy-diluent product.

The pH of the final adhesive composition, either with or without added crosslinker can range from 2-5. Preferably, from 3.5-4.5. Typically, the pH is adjusted to control the reaction rate or stability of the final adhesive. Any suitable acid or base may be used to alter the pH.

The preparation process is typically conducted at room temperature, but it is reasonable to conduct the method at any temperature between 5-50° C.

The low pH soy-diluent adhesive may further include a crosslinking agent, an emulsified polymer, additional diluent, or any combination thereof These additives are used to alter the dry or wet strength, the rheology, or the physical properties of the final adhesive.

### BRIEF DESCRIPTION OF THE FIGURES

FIG. 1 is the dry strength results from Example 2

FIG. 2 is the wet strength results from Example 2

FIG. 3 is the viscosity results from Example 3 and 4 (L) denotes low pH (<5) and H denotes high pH (>5)

FIG. 4 is the viscosity results from Example 5-4 and 6-4 over time

### DETAILED DESCRIPTION OF THE INVENTION

In the specification and in the claims, the terms “including” and “comprising” are open-ended terms and should be interpreted to mean “including, but not limited to. . . . ” These terms encompass the more restrictive terms “consisting essentially of” and “consisting of.”

As used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

The present invention provides a novel adhesive by combining a non-urea diluent with soy flour and lowering the pH to less than 5. The diluent may be added to a soy flour water mixture or the soy flour may be added to a water-diluent mixture.

The term diluent is meant to describe any non-urea additive that can be added to soy flour and result in a homogenous mixture. In the preferred embodiment urea is not added to or present in the adhesive.

Urea may not be used in this invention since the soy flour will is not to be denatured and the urease is to remain. Wescott also showed in U.S. patent application Ser. No. 12/869,848 and Ser. No. 12/507,247 that the urease must be denatured (enzyme activity killed) in order for urea to be a viable diluent. In this application, we are using urease active soy flour.

One aspect of the present invention provides a method for making a stable adhesive, the method comprising the steps of providing an aqueous mixture of soy flour, adding a non-urea diluent and lowering the pH to less than 5.0, preferably less than 4.5.

In another embodiment, the non-urea diluent is added to the water before the soy flour.

It is absolutely essential to lower the pH of the soy flour of the present invention. The acid used to treat the soy flour may be of either a Bronsted or Lewis acid classification. The use of common mineral acids, such as sulfuric or hydrochloric acid is preferred.

The amount of diluent added to the soy flour depends on the needs of the adhesive. For instance, the diluent content may be adjusted to control the flow characteristics or glass transition temperature (T_{g}) of the final adhesive. This allows the adhesive of the present invention to be spray dried and converted into a useable powder adhesive resin, if desired.

In one embodiment, the amount of diluent added to the soy flour can be from about five parts to one part soy flour (solids/solids) to about 0.1 parts to one part soy flour (solids/solids); most preferably between two parts to one part soy flour to about 0.5 parts to one part soy flour. The soy flour can be added to the aqueous system, before, during or after the addition of the diluent.

The adhesive of the present invention can blended with any emulsion polymer, such as, for example, polyvinyl acetate (PVAc) emulsions, to yield a stable adhesive. The emulsion polymer is added at a level of 0.1 to 80% by dry solids weight based on the dry solids weight of the total adhesive.

Typically, adding unmodified soy flour or NaOH-denatured soy flour directly to emulsified polymer yields resins having poor stability and compatibility. In contrast, adding the stable diluent-soy adhesive of the present invention to an emulsion or dispersed polymer yields a stable, highly compatible adhesive dispersion useful in many industrial applications. Further, the combination is accomplished by simple blending techniques using in line mixing, commercial mix tanks, thin tanks or reactors known to one of skill in the art. The temperature of the blend is not considered to be critical and room temperature is typically employed, although it may be desirable and acceptable to combine the stable soy-diluent adhesive of the present invention with the emulsion or dispersed polymer at higher temperatures depending on the needs of the user. The adjustment of the final pH with acids or bases may be required to ensure optimal stability of the total system. However, these adjustments are typically quite modest and are known to one of skill in the art. For instance, minor adjustments necessary for the stability of the emulsion or dispersion may be desired.

The stable soy-diluent adhesive of the present invention may be used as is or may be further improved by adding a suitable crosslinking agent(s). Crosslinking agents are typically added to adhesives to provide additional performance value, which manipulate existing properties of the adhesive, such as water resistance, solubility, viscosity, shelf-life, elastomeric properties, biological resistance, strength, and the like. The role of the crosslinking agent, regardless of type, is to incorporate an increase in, the crosslink density within the adhesive itself. This is best achieved with crosslinking agents that have several reactive sites per molecule.

The type and amount of crosslinking agent used in the present invention depends on what final properties are desired. Additionally, the type and amount of crosslinking agent used may depend on the characteristics of the soy flour used in the adhesive.

Any protein crosslinking agent known to the art may be used in the method of the present invention. For instance, the crosslinking agent may or may not contain formaldehyde. Although formaldehyde-free crosslinking agents are highly desirable in many interior applications, formaldehyde-containing crosslinking agents remain acceptable for some exterior applications.

Possible formaldehyde-free crosslinking agents for use with the adhesives of the present invention include isocyanates such as polymeric methylene diphenyl diisocyanate (pMDI) and polymeric hexamethylene diisocyanate (pHMDI), amine-epichlorohydrin adducts, epoxy, aldehyde and urea-aldehyde resins capable of reacting with soy flour. When a formaldehyde-free crosslinking agent is employed in the invention, it is used in amounts ranging from 0.1 to 80% on dry weight basis of the total dry adhesive. A preferred formaldehyde-free crosslinking agent is polymeric methylene diphenyl diisocyanate (pMDI) and is used in amounts ranging from 0.1 to 80% of the total dry weight.

Amine-epichlorohydrin resins another class of possible formaldehyde-free crosslinking agent. These are defined as those prepared through the reaction of epichlorohydrin with amine-functional compounds. Among these are polyamidoamine-epichlorohydrin resins (PAE resins), polyalkylenepolyamine-epichlorohydrin (PAPAE resins) and amine polymer-epichlorohydrin resins (APE resins). The PAE resins include secondary amine-based azetidinium-functional PAE resins such as Kymene™ 557H, Kymene™ 557LX, Kymene™ 617, Kymene™ 624 and Hercules CA1000, all available from Hercules Incorporated, Wilmington Del., tertiary amine polyamide-based epoxide-functional resins and tertiary amine polyamidourylene-based epoxide-functional PAE resins such as Kymene™ 450, available from Hercules Incorporated, Wilmington Del. A suitable crosslinking PAPAE resin is Kymene™ 736, available from Hercules Incorporated, Wilmington Del. Kymene™ 2064 is an APE resin that is also available from Hercules Incorporated, Wilmington Del. These are widely used commercial materials. Their chemistry is described in the following reference: H. H. Espy, “Alkaline-Curing Polymeric Amine-Epichlorohydrin Resins”, in Wet Strength Resins and Their Application, L. L. Chan, Ed., TAPPI Press, Atlanta Ga., pp. 13-44 (1994). It is also possible to use low molecular weight amine-epichlorohydrin condensates as described in Coscia (U.S. Pat. No. 3,494,775) as formaldehyde-free crosslinkers.

PAE resins are typically base cured systems. Thus, in the present invention, a combination of soy-diluent and PAE can result in a homogenous mixture that is both viscosity and performance stable for several months. This is a substantial improvement over previous soy-PAE systems, which require blending just prior to application.

Possible formaldehyde-containing crosslinking agents include formaldehyde, phenol formaldehyde, urea formaldehyde, melamine urea formaldehyde, melamine formaldehyde, phenol resorcinol formaldehyde and any combination thereof. When formaldehyde-containing crosslinking agents are employed in the invention they are used in amounts ranging from 1 to 80% of the total adhesive composition based on dry weight. In one embodiment of the invention, the crosslinking agent comprises phenol formaldehyde in amounts ranging from 1 to 80%, of the total dry weight.

Regardless of the specific crosslinking agent(s) used, the crosslinking agent is typically added to the soy-diluent adhesive just prior to use (such as in making a lignocellulosic composite), but may be added days or even weeks prior to use in some situations.

Preferred non-urea diluents include polyols such as glycerol, ethylene glycol, propylene glycol, neopentyl glycol, polymeric version thereof (such as polyethylene glycol-PEG), or any other hydroxyl-containing monomer or polymeric material available. Glycerol is most preferred and any grade is acceptable. The addition of soy oil or any other water dispersible fatty acid or triglyceride is also acceptable, as long as a homogenous mixture can be realized. Other additional diluents that serve only to extend the solids are also acceptable, such as flours, talcs, clays and the like.

The non-urea diluent may be incorporated at levels ranging from 0.1 to upwards of 70% by weight of the total adhesive based on dry weight of solids. These may be incorporated during any step of the process including before, during or after the soy flour addition.

Process or performance modifiers, such as defoamers, wetting agents and the like that are commonly employed in the art may also be added to the final adhesive.

The use of traditional soy protein modifiers may be used, as well; such as the addition of sodium bisulfite to reduce the viscosity by reduction of disulfide bonds.

The final pH of the soy/diluent adhesives of the present invention can be adjusted with any suitable Bronsted of Lewis acid or base. The final pH of the adhesives of this invention is less than 5, preferably less than 4.5 and greater than 2.0, preferably greater than 3.0. One of skill in the art will understand how to both manipulate the pH of the adhesive (described in the examples below) and what applications require an adhesive having a higher or lower pH. Typically, the final pH will be selected based on the application or the type of crosslinker used.

The method of the present invention may also include adding a spray- or freeze-drying step to produce a powder adhesive.

The stable soy-diluent adhesive of the present invention can be used in many industrial applications. For instance, the adhesive may be applied to a suitable substrate in amounts ranging from 1 to 25% by dry weight (1 part dry adhesive per 100 parts substrate to 25 parts dry adhesive per 100 parts substrate), preferably in the range of 1 to 10% by weight and most preferably in the range of 2 to 8% by weight. Examples of some suitable substrates include, but are not limited to, a lignocellulosic material, pulp or glass fiber. The adhesive can be applied to substrates by any means known to the art including roller coating, knife coating, extrusion, curtain coating, foam coaters and spray coaters such as a spinning disk resin applicator.

One of skill will understand how to use adhesives/dispersions of the present invention to prepare lignocellulosic composites using references known to the field. See, for example, “Wood-based Composite Products and Panel Products”, Chapter 10 of Wood Handbook—Wood as an Engineering Material, Gen. Tech. Rep. FPL-GTR-113, 463 pages, U.S. Department of Agriculture, Forest Service, Forest Products Laboratory, Madison, Wis. (1999). A number of materials can be prepared using the adhesive/dispersion of the invention including particleboard, oriented strand board (OSB), waferboard, fiberboard (including medium-density and high-density fiberboard), parallel strand lumber (PSL), laminated strand lumber (LSL), oriented strand lumber (OSL) and other similar products. Lignocellulosic materials such as wood, wood pulp, straw (including lice, wheat or barley), flax, hemp and bagasse can be used in making thermoset products from the invention. The lignocellulosic product is typically made by blending the adhesive with a substrate in the form of powders, particles, fibers, chips, flakes fibers, wafers, trim, shavings, sawdust, straw, stalks or shives and then pressing and heating the resulting combination to obtain the cured material. The moisture content of the lignocellulosic material should be in the range of 2 to 20% before blending with the adhesive of the present invention.

The adhesive of the present invention also may be used to produce plywood or laminated veneer lumber (LVL). For instance, in one embodiment, the adhesive may be applied onto veneer surfaces by roll coating, knife coating, curtain coating, or spraying. A plurality of veneers is then laid-up to form sheets of required thickness. The mats or sheets are then placed in a press (e.g., a platen), usually heated, and compressed to effect consolidation and curing of the materials into a board. Fiberboard may be made by the wet felted/wet pressed method, the dry felted/dry pressed method, or the wet felted/dry pressed method.

In addition to lignocellulosic substrates, the adhesives of the present invention can be used with substrates such as plastics, glass wool, glass fiber, other inorganic materials and combinations thereof.

The following examples are, of course, offered for illustrative purposes only, and are not intended to limit the scope of the present invention in any way. Indeed, various modifications of the invention in addition to those shown and described herein will become apparent to those skilled in the art from the foregoing description and the following examples and fall within the scope of the appended claims.

### EXAMPLES AND EVALUATION METHODOLOGIES

The following characteristics of the adhesives were evaluated:

1) Physical Properties—Brookfield viscosity (RV @10 RPMs in all cases) with the spindle selection depending upon the viscosity of the product, pH, and room temperature stability (viscosity and biological-as determined by the obvious onset of the soy rotting or spoiling similar to milk). To reduce the impact of a temporary viscosity increase due to the, often, thixotropic nature of soy adhesives, the adhesive is rapidly stirred for 30 seconds prior to any viscosity measurement.

2) Adhesive Bond Strength—As determined by the following ABES and particleboard procedures:

### ABES Procedure.

Sample Preparation: Wood samples were stamped out using the Automated Bonding Evaluation System (ABES) stamping apparatus from maple veneers such that the final dimensions were 11.7 cm along the grain, 2.0 cm perpendicular to the grain and 0.08 cm thick. The adhesive to be tested was applied to one end of the sample such that the entire overlap area is covered, generally being in the range of 3.8-4.2 mg/cm² on a wet basis. The sample was then bonded to a second veneer (open time of less than 15 seconds to ensure excellent transfer) and placed in the ABES unit such that the overlap area of the bonded samples was 1.0 cm by 2.0 cm. Unless otherwise noted, all samples were pressed for 2.0 minutes at 120° C., with 9.1 kg/cm² of pressure. All bonded samples were then allowed to condition for at least 48 hours in a controlled environment at 22° C. and 50% relative humidity.

Strength Testing: For each resin, ten samples were prepared in the manner described above. After conditioning, five of the ten samples were tested using the ABES instrument in the dry condition. Maximum load upon sample breakage was recorded. These were termed the dry strength samples. The remaining five samples were placed in a water bath at 22° C. for four hours. The samples were removed from the water bath and immediately tested in the manner described above. These samples were termed the wet samples. For each resin, the value reported is an average of the five samples. The error reported is the standard deviation. Typical coefficients of variations (COVs) for this method are around 15% for both dry and wet evaluations; this is considered to be excellent in light of the variability within the wood itself.

Particleboard Qualification—Sample were prepared using the “Particleboard Procedure” outlined below and then evaluated for internal bond (IB), modulus of rupture (MOR) and modules of elasticity (MOE).

### Particleboard Procedure for 12″×12″ Carver Electric Hydraulic Press

The target density and thickness for these panels was 46 lb/ft³ with a thickness of ½″. Commercial face furnish was used throughout the panels. Furnish was 1.5-4.0% MC. Press temperature was 170° C.

Particleboard Procedure: Weigh the face furnish into an approved container and place into a blending bowl. Weigh the resin such that 7.0% solid resin to dry furnish is used (nearest 0.0 g) into a syringe attached to an air atomized spray nozzle and apply to furnish. Allow the blender to mix for 1 minute to sheer blend the resinated particles. Place release paper on a lab caul plate and a 10″×10″ forming box on top of the release paper. Place the resinated furnish into the forming box in a semi even layer. Form the mat by manually spreading the furnish across the caul plate. It is important that the layer be as evenly spread as possible to avoid density distribution issues. Press the panel on a cold press at 100 psi for 60 seconds. Place the second piece of release paper and caul plate on top of the pre-pressed mat. Place into hot press and close the press to ½″ stops and hold for 4 min. Remove the panel from the hot press and cool to room temperature. Trim the panels to 9″×9″ and condition all testing samples for at least 48 hours in an environmentally controlled room at 80° F. and 30% relative humidity prior to testing.

Raw materials for these examples are as follows: Soy Flour: Soy Flour-90 (90 PDI, 200 mesh) supplied by Cargill (Decator, Ill.); pMDI: Rubunate™ FC3345 supplied by Huntsman International (Woodlands, Tex.); PVAc: Duracet supplied by Franklin (Columbus, Ohio); Other Diluents: supplied by Aldrich (Milwaukee, Wis.)

### EXAMPLE 1

Several soy-diluent systems were prepared using a variety of diluents types and amounts, as well as, varying total solids and final pH.

Standard Preparation Procedure: In a round bottom flask, water and the non-urea diluent were charged. Sodium bisulfate was then added to a level of 1% to dry soy flour. The soy flour was then added over 1-5 minutes with rapid stirring. The mixture was allowed to stir for 15-30 minutes. The pH was then adjusted to the desired end point by the drop-wise addition of 50% sulfuric acid. Table 1 below shows the characteristics of these specific examples.

TABLE 1
Characteristics of Example 1 Soy-Diluent Products

| | Non-Urea Diluent | | | | |
|---|---|---|---|---|---|
| | | Amount | | | Viscosity |
| Example | Type | (S:D) | Solids (%) | pH | (cP) |
| 1-1 | G | 2 | 40 | 4.2 | 2100 |
| 1-2 | G | 2 | 40 | 6.2 | 1600 |
| 1-3 | EG | 2 | 40 | 4.0 | 2220 |
| 1-4 | DEG | 2 | 40 | 3.9 | 3020 |
| 1-5 | PEGmw300 | 2 | 40 | 3.3 | 1030 |
| 1-6 | PEGmw8000 | 2 | 35 | 3.8 | 2350 |
| 1-7 | PPG | 2 | 40 | 3.9 | 1820 |
| 1-8 | G | 1 | 50 | 3.9 | 1150 |
| 1-9 | G | 1 | 50 | 6.2 | 1700 |
| 1-10 | G | 1 | 55 | 6.1 | 7500 |
| 1-11 | G | 1 | 60 | 6.1 | 19400 |
| 1-12 | G | 0.5 | 55 | 3.2 | 490 |
| 1-13 | G | 0.5 | 55 | 3.9 | 520 |
| 1-14 | G | 0.5 | 55 | 4.8 | 550 |
| 1-15 | G | 0.5 | 55 | 5.9 | 560 |
| 1-16 | G | 0.5 | 55 | 6.8 | 630 |
| 1-17 | G | 0.5 | 55 | 8.2 | 700 |

Note:
G = glycerol,
EG = ethylene glycol,
PPG = propylene glycol,
PEG = polyethylene glycol

The results in Table 1 show the versatility of the invention to produce high solid, low viscosity adhesives over a wide range of diluent types and levels.

### EXAMPLE 2

### Blends with pMDI

Several base resins as described in Example 1 were combined with pMDI (Rubunate™ FC3345) to assess the impact on both bond performance (as measured by the ABES method) and on physical properties. The non-urea diluents selected were glycerol (G), ethylene glycol (EG) and the PEG-8000MW (PEG). The mixing was conducted in a beaker or round-bottom flask with simple mixing for 5 minutes prior to evaluation. All of the blends were homogeneous and easy to handle. The characteristics of these blends are shown in Table 2.

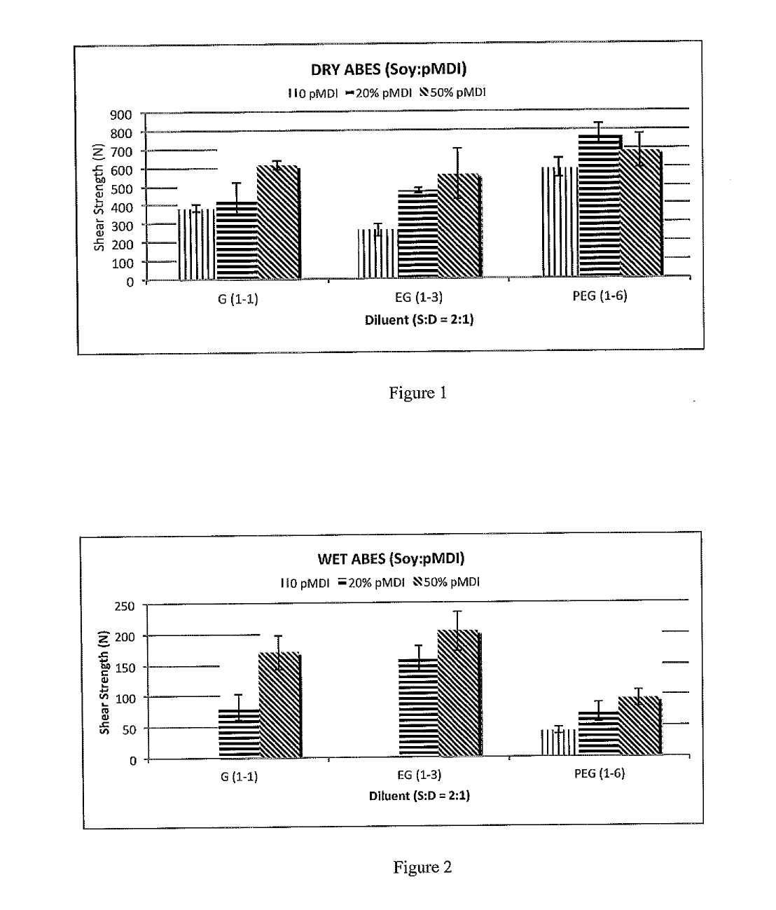

The dry and wet strengths of the adhesives described in Table 2 were evaluated using the ABES method. These results are shown in Table 3 and FIGS. 1 and 2.

TABLE 2
Characteristics of Soy:Diluents Blended with pMDI

| | Base | Diluent | pMDI | Solids | | Viscosity |
|---|---|---|---|---|---|---|
| Example | Resin | Type | (PPH)* | (%) | pH | (cP) |
| 2-1 | 1-1 | G | 0 | 40.0 | 4.23 | 2100 |
| 2-2 | | G | 20 | 45.5 | 4.07 | 2740 |
| 2-3 | | G | 50 | 50.0 | 3.97 | 3770 |
| 2-4 | 1-3 | EG | 0 | 40.0 | 4.00 | 2220 |
| 2-5 | | EG | 20 | 45.5 | 3.96 | 2840 |
| 2-6 | | EG | 50 | 50.0 | 3.97 | 3740 |
| 2-7 | 1-6 | PEG | 0 | 35.0 | 3.77 | 2350 |
| 2-8 | | PEG | 20 | 40.2 | 3.98 | 6400 |
| 2-9 | | PEG | 50 | 44.7 | 3.87 | 7160 |

TABLE 3
Bond Strength (ABES) of Soy:Diluents Blended with pMDI

| | | | | Dry | Wet |
|---|---|---|---|---|---|
| | Base | | | Strength | Strength |
| Example | Resin | DiluentType | pMDI (PPH)* | (N) | (N) |
| 2-1 | 1-1 | G | 0 | 383 | 0 |
| 2-2 | | G | 20 | 438 | 82 |
| 2-3 | | G | 50 | 613 | 170 |
| 2-4 | 1-3 | EG | 0 | 261 | 0 |
| 2.5 | | EG | 20 | 475 | 159 |
| 2-6 | | EG | 50 | 561 | 203 |
| 2-7 | 1-6 | PEG | 0 | 592 | 42 |
| 2-8 | | PEG | 20 | 776 | 73 |
| 2-9 | | PEG | 50 | 684 | 94 |

Discussion of Example 2: The addition of pMDI to the soy-diluent system produces a final adhesive with significantly higher dry and wet strengths. Furthermore, these adhesives are homogenous, which in light of the organic nature of the pMDI material, is rather surprising and fortuitous, and the final solids and viscosity values are well suited for commercial spraying applications.

### EXAMPLE 3

### Viscosity and Viscosity Stability of Soy:Diluent (S:G=1:1) Blended with pMDI (pH<5)

The present invention is of significance because of its ability to produce, not only high solids and low viscosity resins, but also because of its ability to produce adhesive formulations that show a significant improvement in viscosity stability over the prior art.

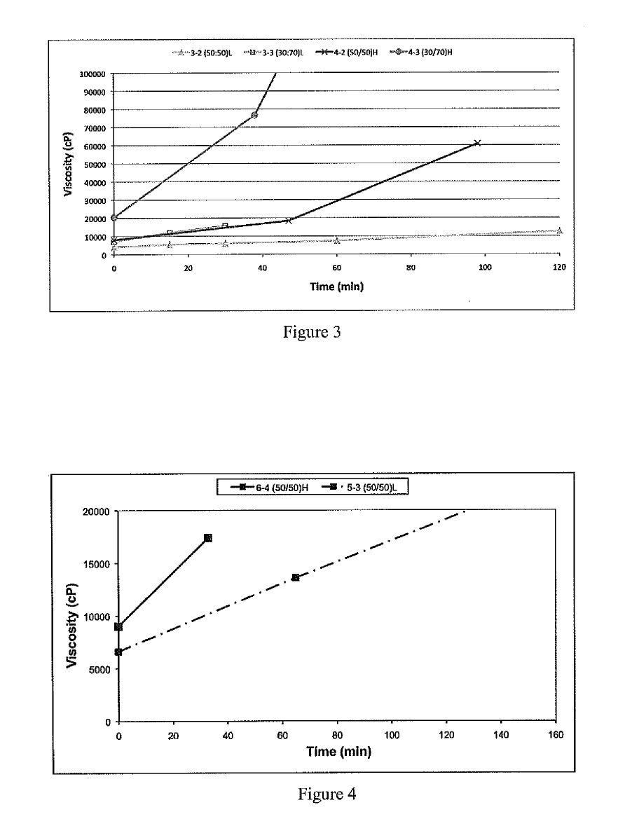

Resins from Example 1 were blended with pMDI in a manner similar to that described in Example 2. In this Example, the pH of the starting resin is less than 5 to demonstrate the benefit of obtaining a final adhesive that is both lower in viscosity and one that exhibits better viscosity stability. These results are shown in Table 4 and FIG. 3 along with results of Example 4 (pH>5).

### EXAMPLE 4: (COMPARABLE EXAMPLE)

### Viscosity and Viscosity Stability of Soy:Diluent Blended (S:G=1:1) with pMDI (pH>5)

Identical to Example 3, but with a pH>5.

TABLE 4
Initial Viscosity and Viscosity Stability of Soy:Diluent
(1:1) Blended with pMDI as a Function of pH

| | | | | |
|---|---|---|---|---|
| | | Soy-Dil/ | Time | Viscosity |
| Example | pH | pMDI | (min) | (CP) |

Base Resin: Example 1-8

| | | | | |
|---|---|---|---|---|
| 1-8 | 3.9 | 100/0 | | 1,150 |
| 3-1 | | 70/30 | 0 | 2,200 |
| | | | 15 | 2,400 |
| | | | 30 | 2,500 |
| | | | 60 | 2,770 |
| | | | 120 | 3,090 |
| 3-2 | | 50/50 | 0 | 4,000 |
| | | | 15 | 5,400 |
| | | | 30 | 6,000 |
| | | | 60 | 7,340 |
| | | | 120 | 12,500 |
| 3-3 | | 30/70 | 0 | 7,000 |
| | | | 15 | 12,000 |
| | | | 30 | 15,740 |
| | | | 60 | |
| | | | 120 | |

Base Resin: Similar to Example 1-9

| | | | | |
|---|---|---|---|---|
| Like | 6.2 | 100/0 | | 2,030 |
| 1-9 | | | | |
| 4-1 | 6.0 | 70/30 | 0 | 4,760 |
| | 5.9 | | 36 | 7,080 |
| | 5.9 | | 75 | 9,480 |
| 4-2 | 5.9 | 50/50 | 0 | 8,000 |
| | 5.9 | | 47 | 18,400 |
| | 5.8 | | 98 | 60,800 |
| 4-3 | | 30/70 | 0 | 20,300 |
| | | | 38 | 76,700 |
| | | | 77 | 271,200 |

### EXAMPLE 5

### Viscosity and Viscosity Stability of Soy:Diluent (S:G=2:1) Blended with pMDI (pH<5)

Identical to Example 3, but with an S:G=2.0

### EXAMPLE 6

### Viscosity and Viscosity Stability of Soy:Diluent Blended (S:G=2:1) with pMDI (pH>5)

Identical to Example 5, but with a pH>5.

TABLE 5
Initial Viscosity and Viscosity Stability of Soy:Diluent
(2:1) Blended with pMDI as a Function of pH

| | | | | |
|---|---|---|---|---|
| | | Soy-Dil/ | Time | Viscosity |
| Example | pH | pMDI | (min) | (CP) |

Base Resin: Example 1-1

| | | | | |
|---|---|---|---|---|
| 5-1 | 4.2 | 100/0 | 0 | 2100 |
| | | | 120 | 2100 |
| 5-2 | 4.1 | 80/20 | 0 | 2740 |
| | | | 25 | 2920 |
| | | | 66 | 3610 |
| 5-3 | 4.0 | 67/33 | 0 | 3770 |
| | | | 56 | 9320 |
| | | | 88 | 12960 |
| 5-4 | 4.1 | 50/50 | 0 | 6620 |
| | | | 65 | 13600 |
| | | | 146 | 21760 |

Base Resin: Example 1-2

| | | | | |
|---|---|---|---|---|
| 6-1 | 6.2 | 100/0 | 0 | 1600 |
| | | | 120 | 1600 |
| 6-2 | 6.3 | 80/20 | 0 | 4020 |
| | | | 29 | 6020 |
| 6-3 | 6.2 | 67/33 | 0 | 6100 |
| | | | 29 | 10400 |
| 6-4 | 6.3 | 50/50 | 0 | 9000 |
| | | | 33 | 17400 |

FIG. 4 graphically represents the data for the 50/50 soy/diluent of example 5.4 (low pH) and 6-4 (higher pH)

Discussion of Examples 3-6: A reduction in pH to less than 5, clearly results in a significant improvement in viscosity stability; as observed by both the lower initial viscosity values and also, the reduced slopes of the viscosity stability curves. This trend is most pronounced in high crosslink concentration systems, such as with 50% pMDI.

### EXAMPLE 7

### Particleboard Panels

Several laboratory particleboard panels were made from the resin described in Example 1-8 after blending with various amounts of pMDI, per the procedure described in Example 2. The final pH of all formulations was less than 5. The particleboard preparation procedure is described previously in this document. Several levels of pMDI addition were evaluated in this example. In addition, Examples 7-1 and 7-2 are 100% pMDI control panels at two different loading levels. These results are shown in Table 6.

TABLE 6
Particleboards Made From Soy:Diluent-pMDI Blends

| | | Resin Load | | | | | | | | |
|---|---|---|---|---|---|---|---|---|---|---|
| Board | Resin | Total | pMDI | pMDI (% | Furnish | Mat | IB | Density | MOR | MOE |
| # | Solids (%) | (%) | (%) | of Total) | MC (%) | MC (%) | (PSI) | (lb/ft3) | (PSI) | (PSI) |
| 7-1 | 100 | 1.5 | 1.5 | 100.0 | 9.5 | 9.4 | 74.1 | 45.0 | 1231 | 1.80E+05 |
| | | | | | | | (29.4) | | (102) | (1.43E+04) |
| 7-2 | 100 | 3.0 | 3.0 | 100.0 | 9.5 | 9.2 | 149.8 | 45.0 | 2198 | 2.56E+05 |
| | | | | | | | (31.1) | | (258) | (3.83E+04) |
| 7-3 | 66.7 | 3.0 | 1.5 | 50.0 | 8.1 | 9.3 | 124.4 | 45.0 | 1772 | 2.45E+05 |
| | | | | | | | (48.6) | | (148) | (1.95E+04) |
| 7-4 | 52.4 | 7.0 | 0.6 | 9.1 | 4.3 | 10.0 | 62.9 | 45.0 | 1018 | 2.23E+05 |
| | | | | | | | (13.3) | | (196) | (7.40E+04) |
| 7-5 | 54.6 | 7.0 | 1.2 | 16.7 | 4.9 | 10.0 | 131.6 | 45.0 | 1694 | 2.75E+05 |
| | | | | | | | (21.9) | | (89) | (1.84E+04) |
| 7-6 | 56.5 | 7.0 | 1.6 | 23.1 | 5.3 | 10.0 | 133.2 | 45.0 | 1994 | 2.82E+05 |
| | | | | | | | (37.4) | | (217) | (2.90E+04) |

Discussion of Example 7: The ability of the soy-diluent based adhesives to produce high strength particleboard panels has been demonstrated. Most notably, the soy-diluent examples (7-3 and 7-6) are both significantly higher strength panels than the comparably loaded pMDI control panel (7-1). This demonstrates the ability to produce quality pMDI panels with a significant reduction in the amount of pMDI used.

We claim:

1. A stable adhesive composition comprising non-urea diluent and soy flour in water wherein the pH is less than 5.0 and wherein no urea is added to the composition.

2. The composition of claim 1 further comprising a crosslinking agent.

3. The composition of claim 2 wherein the amount of the crosslinking agent in the composition is 0.1 to 80% solids based on the total dry weight.

4. The composition of claim 2 wherein the crosslinking agent comprises a formaldehyde-free crosslinking agent selected from the group consisting of isocyanate, polyamine epichlorohydrin resin, polyamidoamine-epichlorohydrin resin, polyalkylene polyamine-epichlorohydrin, amine polymer-epichlorohydrin resin epoxy, aldehyde, aldehyde starch, dialdehyde starch, glyoxal, urea glyoxal, urea-aldehyde resin and mixtures thereof.

5. The composition of claim 2 wherein the crosslinking agent comprises an isocyanate.

6. The composition of claim 2 wherein the crosslinking agent comprises a polymeric methylene diphenyl diisocyanate.

7. The composition of claim 2 wherein the crosslinking agent comprises a polyamidoamine-epichlorohydrin resin.

8. The composition of claim 2 wherein the crosslinking agent comprises a formaldehyde-containing crosslinking agent selected from the group consisting of formaldehyde, phenol formaldehyde, melamine formaldehyde, urea formaldehyde, melamine urea formaldehyde, phenol resorcinol formaldehyde and any combination thereof.

9. The composition of claim 1 further comprising the addition of an emulsion polymer.

10. The composition of claim 9 wherein the amount of the emulsion polymer in the composition is from 0.1 to 80% by dry weight based on the total dry weight.

11. The composition of claim 9 wherein the emulsion polymer comprises a polyvinyl acetate (PVAc).

12. The composition of claim 1 further comprising a diluent.

13. The composition of claim 12, wherein the diluent is selected from the group consisting of glycerol, ethylene glycol, propylene glycol, neopentyl glycol, polymeric versions thereof and combinations thereof.

14. The composition of claim 12, wherein the diluent is glycerol.
